(19) United States
(12) Patent Application Publication
(10) Pub. No.: US 2026/0183739 A1
(43) Pub. Date: Jul. 2, 2026

(54) MODULAR METAL FLOW REACTORS WITH METAL STRUCTURES ENABLING RECONFIGURABLE PROCESS FLUID FLOW, HIGH THERMAL STABILITY, AND HIGH WORKING PRESSURE

(71) Applicant: CORNING INCORPORATED, CORNING, NY (US)

(72) Inventor: Sylvain Maxime F Gremetz, Varennes sur Seine (FR)

(21) Appl. No.: 19/131,727

(22) PCT Filed: Nov. 15, 2023
(86) PCT No.: PCT/US2023/079814

§ 371 Date: May 21, 2025

Related U.S. Application Data
(60) Provisional application No. 63/428,229, filed on Nov. 28, 2022.

(51) Int. Cl. B01J 19/24

(52) U.S. Cl. CPC B01J 19/249; B01J 2219/2461; B01J 2219/2493; B01J 2219/2496

(57) ABSTRACT

A flow reactor comprises a frame, fluidic modules supported by the frame, metal plates between which the fluidic modules are arranged one by one in a first direction, metal inserts, and tightening members extending in the first direction through the metal plates and the fluidic modules. Each fluidic module comprise a metal reaction layer with opposed major outer surfaces, a fluid passage disposed therein, and module ports that extend between the major outer surfaces. The module ports comprise intersecting ports that intersect the fluid passage. Each metal plate has plate ports corresponding to the module ports. Each metal insert abuts a corresponding pair of ports adjacently spaced in the first direction such that every intersecting port is abutted by at least one metal insert. The tightening members compress the two metal plates and the fluidic modules against the metal inserts.

### CROSS-REFERENCE TO RELATED APPLICATIONS

This application claims the benefit of priority under 35 U.S.C. § 119 of U.S. Provisional Application No. 63/428,229 filed Nov. 28, 2022, the content of which is incorporated herein by reference in its entirety.

### FIELD

The present disclosure relates to metal flow reactors with stacked metal fluidic modules. In particular, the present disclosure relates to metal structures configured to compress the stacked fluidic modules against interchangeable metal inserts positioned relative to ports of the fluidic modules so as to enable a reconfigurable process flow through the reactor, high thermal stability, and high working pressure.

### BACKGROUND

Many conventional flow reactors include fluidic modules formed from glass and/or ceramic (with metal free connection). Such convention flow reactors may have boundary conditions limited to a maximum temperature of about 200° C. and a maximum working pressure of about 18 bar. Some chemistries may benefit from higher working pressures. Consequently, it would be advantageous to develop metal flow reactors capable of operating at such higher working pressures.

### SUMMARY

Aspects of the disclosure relate to metal flow reactors and methods for their manufacture and use. Metal flow reactors disclosed herein include metal structures that enable reconfigurable process fluid flows, high thermal stability, and expanded boundary conditions.
According to aspect (1), a flow reactor is provided. The flow reactor comprises: a frame; a plurality of fluidic modules supported by the frame, each fluidic module comprising a metal reaction layer having opposed major outer surfaces, a fluid passage disposed within the metal reaction layer, and a plurality of module ports extending between the major outer surfaces of the metal reaction layer, the module ports comprising intersecting ports that intersect the fluid passage; at least two metal plates between which the fluidic modules are arranged one by one in a first direction that is substantially normal to the major outer surfaces, the at least two metal plates supported by the frame with each metal plate having a plurality of plate ports; a plurality of metal inserts, each metal insert configured to abut a corresponding pair of ports adjacently spaced in the first direction and comprising at least one intersecting port such that every intersecting port is abutted by at least one metal insert; and at least two tightening members extending in the first direction through the at least two metal plates and the fluidic modules, the at least two tightening members configured to compress the at least two metal plates and the fluidic modules against the metal inserts.
According to aspect (2), the flow reactor of aspect (1) is provided, wherein the at least two metal plates comprise a first metal plate fixed to the frame and a second metal plate supported by the frame, the fluidic modules arranged between the first and second metal plates.
According to aspect (3), the flow reactor of any one of the preceding aspects is provided, wherein, when viewed in the first direction, the module ports of each fluidic module are positioned between the at least two tightening members.
According to aspect (4), the flow reactor of any one of the preceding aspects is provided, wherein the at least two tightening members are positioned symmetrically about the module ports of each fluidic module.
According to aspect (5), the flow reactor of any one of the preceding aspects is provided, wherein the module ports of each fluidic module are aligned along a common line oriented substantially normal to the first direction.
According to aspect (6), the flow reactor of aspect (5) is provided, wherein the at least two tightening members are aligned along the common line.
According to aspect (7), the flow reactor of aspect (5) or aspect (6) is provided, wherein the metal reaction layer of each fluidic module has a plurality of edges extending between the major outer surfaces thereof, the module ports of each fluidic module positioned closer to one of the edges.
According to aspect (8), the flow reactor of aspect (7) is provided, wherein the common line is oriented substantially parallel to the one edge.
According to aspect (9), the flow reactor of any one of the preceding aspects is provided, wherein each tightening member is elongate in the first direction.
According to aspect (10), the flow reactor of any one of the preceding aspects is provided, wherein each tightening member has at least two contact portions configured to abut respective outer surfaces of the at least two metal plates.
According to aspect (11), the flow reactor of aspect (10) is provided, wherein at least one contact portion of each tightening member is configured to adjust a distance along the tightening member between the at least two contact portions.
According to aspect (12), the flow reactor of aspect (11) is provided, wherein each tightening member is configured as a threaded rod and at least one contact portion of each tightening member is configured as a threaded nut that engages the threaded rod.
According to aspect (13), the flow reactor of aspect (12) is provided, wherein each contact portion of each tightening member is configured as a threaded nut that engages the threaded rod.
According to aspect (14), the flow reactor of any one of the preceding aspects is provided, wherein each metal insert comprises a first body portion that is monolithic and extends between opposed end faces thereof along a central axis oriented substantially parallel to the first direction.
According to aspect (15), the flow reactor of aspect (14) is provided, wherein the first body portion is elongate in the first direction.
According to aspect (16), the flow reactor of aspect (14) or aspect (15) is provided, wherein the first body portion has a cylindrical shape when viewed in a cross section oriented substantially normal to the first direction.
According to aspect (17), the flow reactor of any one of aspects (14)-(16) is provided, wherein each end face of each metal insert has a surface portion oriented substantially normal to the first direction.
According to aspect (18), the flow reactor of aspect (17) is provided, wherein each surface portion of each metal insert is configured to abut one or more of the major outer surface proximate each module port and a plate surface proximate each plate port.
According to aspect (19), the flow reactor of any one of aspects (14)-(18) is provided, wherein each end face of each metal insert has a protrusion that extends therefrom, the protrusions configured to be received in the corresponding pair of ports abutted by the metal insert.
According to aspect (20), the flow reactor of aspect (19) is provided, wherein the protrusions of each metal insert are arranged concentrically with respect to the central axis of the first body portion.
According to aspect (21), the flow reactor of any one of the preceding aspects is provided, wherein the metal inserts comprise first inserts configured to interchangeably abut the corresponding pairs of ports, each first insert configured to a set a first flow condition in which the ports of the corresponding pair of ports are fluidically connected to one another.
According to aspect (22), the flow reactor of any one of the preceding aspects is provided, wherein the metal inserts comprise second inserts configured to interchangeably abut the corresponding pairs of ports, each second insert configured to set a second flow condition in which the ports of the corresponding pair of ports are fluidically isolated from one another.
According to aspect (23), the flow reactor of any one of the preceding aspects is provided, wherein the metal inserts comprise third inserts configured to interchangeably abut the corresponding pairs of ports, each third insert configured to set a third flow condition in which the ports of the corresponding pair of ports are fluidically connected to one another and to a first port.
According to aspect (24), the flow reactor of any one of the preceding aspects is provided, wherein the metal inserts comprise fourth inserts configured to interchangeably abut the corresponding pairs of ports, each fourth insert configured to set a fourth flow condition in which (i) the ports of the corresponding pair of ports are fluidically isolated from one another and (ii) one port of the corresponding pair of ports is fluidically connected to a second port.
According to aspect (25), the flow reactor of any one of the preceding aspects is provided, wherein the metal reaction layer of each fluidic module, the at least two metal plates, the metal inserts, and portions of the at least two tightening members are formed from a same metal.
According to aspect (26), the flow reactor of aspect (25) is provided, wherein the same metal comprises one of stainless steel, Hastelloy®, titanium, and tantalum.
According to aspect (27), the flow reactor of aspect (25) or aspect (26) is provided, wherein one or more of the fluidic modules comprises a heat exchanger, each heat exchanger comprising two heat exchange layers attached, respectively, to the major outer surfaces of the metal reaction layer of each of the one or more fluidic modules to define heat exchange fluid passages therebetween.
According to aspect (28), the flow reactor of aspect (27) is provided, wherein each heat exchange layer has a recessed portion that delimits an exposed portion of the major outer surface that is not covered by the beat exchange layer, the module ports of each of the one or more fluidic modules disposed within the exposed portion.
According to aspect (29), the flow reactor of aspect (27) or aspect (28) is provided, wherein at least one adjacent pair of the fluidic modules comprises the heat exchangers, the metal inserts disposed between the at least one adjacent pair of the fluidic modules configured to provide a minimum gap between the heat exchangers in the first direction.
According to aspect (30), the flow reactor of aspect (29) is provided, wherein the minimum gap is at least 1 mm.
According to aspect (31), the flow reactor of any one of aspects (27)-(30) is provided, wherein the two heat exchange layers of each heat exchanger are sealed, respectively, to the major outer surfaces of the metal reaction layer of each of the one or more fluidic modules.
According to aspect (32), the flow reactor of any one of aspects (27)-(30) is provided, wherein the two heat exchange layers of each heat exchanger are fastened, respectively, to the major outer surfaces of the metal reaction layer of each of the one or more fluidic modules.
According to aspect (33), the flow reactor of aspect (32) is provided, wherein the two heat exchange layers of each heat exchanger are formed from a first metal that is different than the same metal.
According to aspect (34), the flow reactor of any one of the preceding aspects is provided, wherein the module ports of each fluidic module comprise three module ports.
According to aspect (35), the flow reactor of any one of the preceding aspects is provided, wherein the module ports comprise non-intersecting ports that do not intersect the fluid passage, and wherein the corresponding pair of ports abutted by each metal insert comprises (i) two intersecting ports, (ii) one intersecting port and one non-intersecting port, or (iii) one intersecting port and one plate port.

### BRIEF DESCRIPTION OF THE DRAWINGS

FIG. 1 is a side plan view of a metal flow reactor with metal fluidic modules arranged in a stack between metal plates and supported by a frame according to embodiments;

FIG. 2 is a side plan view of one of the metal fluidic modules of the metal flow reactor of FIG. 1 according to embodiments;

FIG. 3A and FIG. 3B are front plan views of different variants of the metal fluidic module of FIG. 2;

FIG. 4 is a side plan view of one of the metal plates of the metal flow reactor of FIG. 1 according to embodiments; and

FIG. 5 is front plan view of the metal plate of FIG. 4;

FIG. 6 is a schematic diagram of a metal flow reactor with an arrangement of metal fluidic modules compressed against an arrangement of metal inserts that define a process fluid flow through the reactor according to a process & instrumentation diagram (P&ID);

FIG. 7 is a simplified schematic diagram of the metal flow reactor of FIG. 6 with heat exchangers omitted from some of the metal fluidic modules according to embodiments;

FIG. 8 is a simplified schematic diagram of the metal flow reactor of FIG. 6 with a different arrangement of metal fluidic modules compressed against a different arrangement of metal inserts that define a process fluid flow through the reactor according to a different P&ID;

FIGS. 9-19 are views of different variants of the metal inserts of FIG. 6 and FIG. 8;

FIG. 20 and FIG. 21 are cross-sectional views of a metal support along line A-A through the metal flow reactor of FIG. 7; and

FIG. 22 is a schematic diagram of a metal flow reactor with metal fluidic modules having heat exchangers configured to provide at least two different heating zones.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

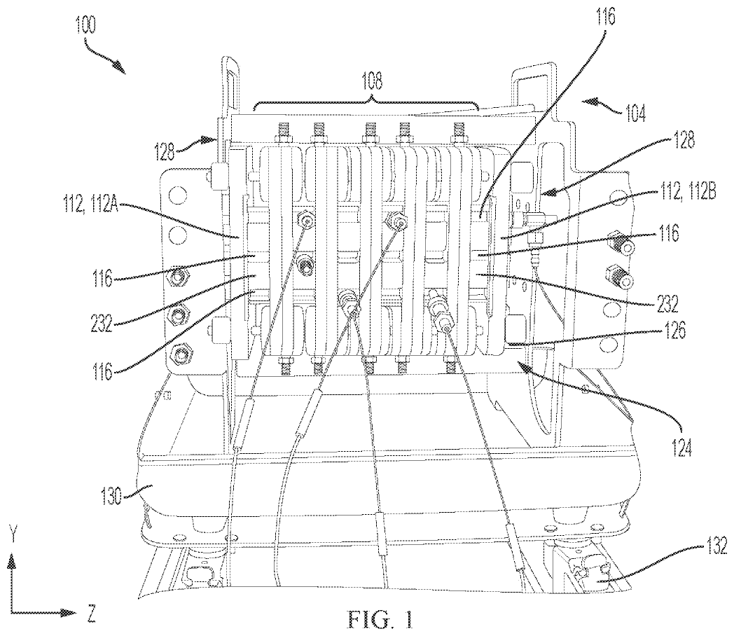

FIG. 1 is a side plan view of a metal flow reactor 100 that includes a frame 104, a plurality of metal fluidic modules 108, at least two metal plates 112, a plurality of metal inserts 116, and at least two tightening members 120 according to embodiments. The frame 104 includes a first support member 124 that defines a first support surface 126 on an upper side of the first support member 124. The frame 104 further includes at least one second support member 128 that extends transversely (e.g., approximately perpendicularly) from an end of the first support member 124. In embodiments, the frame 104 includes two second support members 128 that extend, respectively, from opposite ends of the first support member 124.

The frame 104 is configured to support the various components of the metal flow reactor 100. In embodiments, the frame 104 is formed from a metal. The metal of the frame 104 can be any metal with sufficient strength and durability to support the weight of the various other components of the flow reactor 100 during operation and transit thereof. In embodiments, the frame 104 is formed from stainless steel. In embodiments, the frame 104 rigidly supports or fixes (e.g., via fasteners, adhesives, and/or like mechanical fixation) components of the metal flow reactor 100 such that there is substantially no relative movement between the frame 104 and the rigidly supported or fixed component. In embodiments, the frame 104 slidably supports components of the metal flow reactor 100 such that relative movement between the frame 104 and the slidably supported component is permissible, for example, in a first direction (e.g., the z-direction) or multiple directions (e.g., any direction along a plane defined by the first support surface 126). The frame 104 can define portions (e.g., a base or bottom portion 130) of an enclosure configured to surround components of the metal flow reactor 100. In embodiments, the frame 104 includes a plurality of rollers or wheels 132 that enable the metal flow reactor 100 to be portable.

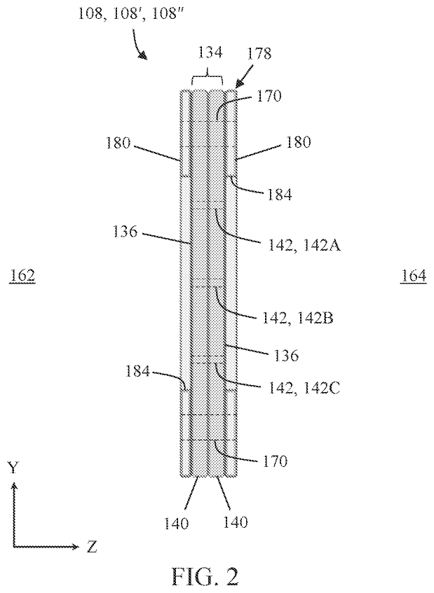

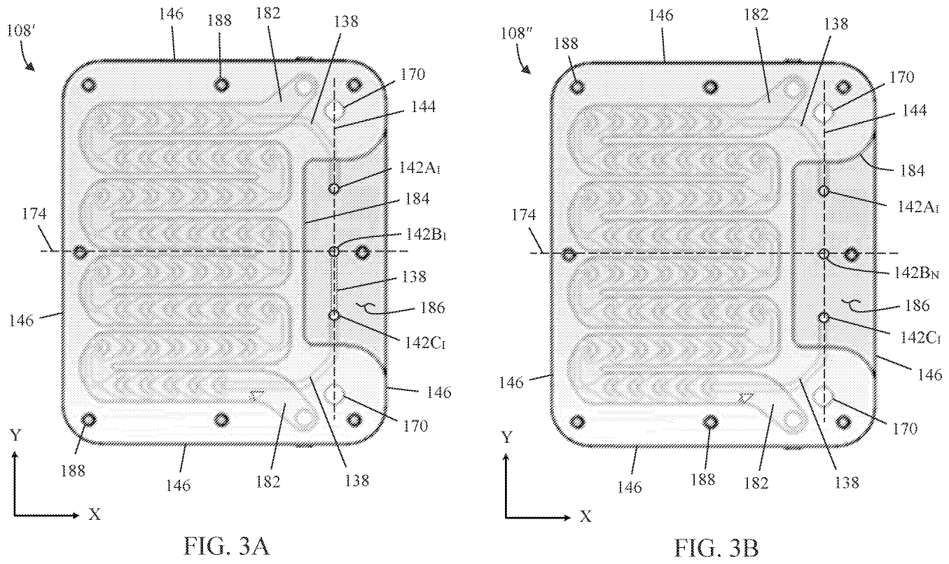

Referring now to FIGS. 2, 3A, and 3B in connection with FIG. 1, aspects of the metal fluidic modules 108 are shown. FIG. 2 is a side plan view of one of the fluidic modules 108 of the metal flow reactor 100 of FIG. 1 according to embodiments. FIG. 3A and FIG. 3B are front plan views of different variants of the metal fluidic module of FIG. 2. The fluidic modules 108 are supported by the frame 104. In embodiments, the fluidic modules 108 are slidably supported on the frame 104, for example, by the first support surface 126 of the first support member 124. The first support surface 126 can permit slidable contact with edges of the fluidic modules 108 to allow relative movement between the fluidic modules 108 and portions of the frame 104. In an exemplary embodiment, the fluidic modules 108 are slidably supported on the frame 104 during assembly/disassembly of the metal flow reactor 100. In embodiments, the fluidic modules 108 can be supported by other portions of the frame 104, such as the second support member 128, such that the fluidic modules 108 may not contact or only partially contact the first support surface 126 of the first support member 124.

In embodiments, each fluidic module 108 comprises a metal reaction layer 134 that has opposed (e.g., opposite facing) major outer surfaces 136 and a fluid passage 138 disposed within the metal reaction layer 134. The metal reaction layer 134 of each fluidic module 108 comprises two metal layers 140 positioned against one another (e.g., to form a metal bilayer) with each metal layer 140 defining one of the major outer surfaces 136 of the metal reaction layer 134. In embodiments, walls of the fluid passage 138 can be defined entirely by only one of the two metal layers 140, or the walls of the fluid passage 138 can be defined partially by both of the metal layers 140. In embodiments, the two metal layers 140 of each metal reaction layer 134 are sealed (e.g., using metal bonding or joining techniques), fastened (e.g., using mechanical fasteners), or a combination thereof to one another to seal the fluid passage 138 and enable the metal reaction layer 134 to withstand a maximum working pressure (e.g., 50 bar or more) during operation of the metal flow reactor 100. In an exemplary embodiment, the two metal layers 140 of each metal reaction layer 134 are sealed to one another. While the metal reaction layer 134 is described as comprising two metal layers positioned against one another, other embodiments of the metal reaction layer are contemplated. For example, in embodiments, the metal reaction layer and the fluid passage disposed therein can be formed via three-dimension (3D) printing techniques using metal powder.

Each fluidic module 108 further comprises a plurality of module ports 142 that extend between the major outer surfaces 136 of the metal reaction layer 134. In an exemplary embodiment, each fluidic module 108 comprises three module ports 142 as shown in FIGS. 2, 3A, and 3B. In embodiments, each fluidic module 108 can comprise more or less than three module ports, for example, two module ports, four module ports, or five module ports. In embodiments, some of the fluidic modules can have a different number of module ports than other fluidic modules in the same metal flow reactor 100.

As shown in FIG. 3A and FIG. 3B, the module ports 142 of each fluidic module 108 are aligned along a common line 144. In embodiments, the common line 144 is oriented substantially normal to the first direction (e.g., the z-direction), such as substantially parallel to the major outer surfaces 136 of the fluidic modules 108. In embodiments, the metal reaction layer 134 of each fluidic module 108 has a plurality of edges 146 that extend between the major outer surfaces 136 thereof. In embodiments, the module ports 142 of each fluidic module 108 are positioned closer to one of the edges 146. In embodiments, the common line 144 is oriented substantially parallel to the one edge.

Referring again to FIGS. 2, 3A, and 3B in connection with FIG. 1, the module ports 142 of each fluidic module 108 are positioned spaced apart from one another from a top side of the metal flow reactor 100 to a bottom side of the metal flow reactor 100. The module ports 142 can be described with reference to their sequential position (along the common line 144) from the top side to the bottom side. For example, the module port closest to the top side can be a first module port 142A, the next module port (along the common line 144) adjacent to the first module port 142A can be a second module port 142B, and so on, such that each of the fluidic modules 108 depicted in FIGS. 2, 3A, and 3B comprise the first module port 142A, the second module port 142B, and a third module port 142C. As noted, the fluidic module 108 can comprise more or less than three module ports 142 in embodiments.

As shown in FIG. 3A and FIG. 3B, the module ports 142 comprise intersecting ports that intersect the fluid passage 138 and (optional) non-intersecting ports that do not intersect the fluid passage 138. The module ports 142 that are configured as intersecting ports can be designated by the sequential position of the module port (e.g., 142A, 142B, 142C, etc.) followed by subscript “1” (e.g., 142A₁, 142B₁, 142C₁, etc.). The module ports 142 that are configured as non-intersecting ports can be designated by the sequential position of the module port (e.g., 142A, 142B, 142C, etc.) followed by subscript “N” (e.g., 142A_{N}, 142B_{N}, 142C_{N}, etc.). While the non-intersecting ports are described as corresponding to module ports 142 that extend through the metal reaction layer 134 but do not intersect the fluid passage 138, in some embodiments it is contemplated that the non-intersecting ports can comprise other non-functional ports, such as a recess in one of the major outer surfaces 136 of the metal reaction layer 134.

In embodiments, the fluidic modules 108 can comprise two or more module variants that differ with respect to the number of module ports 142, the number of intersecting ports, and/or the number of non-intersecting ports. In an exemplary embodiment, the fluidic modules comprise a first module variant 108′ (FIG. 3A) and a second module variant 108″ (FIG. 3B) each of which has three module ports 142A, 142B, 142C. As shown in FIG. 3A, the three module ports 142A, 142B, 142C of the first module variant 108′ can be configured as three intersecting ports. For example, the first module port 142A of the first module variant 108′ can be configured as an intersecting port (e.g., first intersecting port 142A₁) that intersects an outlet end of the fluid passage 138. The second module port 142B of the first module variant 108′ can be configured as an intersecting port (e.g., second intersecting port 142B₁) that intersects an inlet end of the fluid passage 138. The third module port 142C of the first module variant 108′ can be configured as an intersecting port (e.g., third intersecting port 142C₁) that intersects the inlet end of the fluid passage 138.

As shown in FIG. 3B, the three module ports 142A 142B, 142C of the second module variant 108″ can be configured as two intersecting ports and one non-intersecting port. For example, the first module port 142A of the second module variant 108″ can be configured as an intersecting port (e.g., first intersecting port 142A₁) that intersects an outlet end of the fluid passage 138. The second module port 142B of the second module variant 108″ can be configured as a non-intersecting port (e.g., second non-intersecting port 142B_{N}) that does not intersect the fluid passage 138. The third module port 142C of the second module variant 108″ can be configured as an intersecting port (e.g., third intersecting port 142C₁) that intersects an inlet end of the fluid passage 138. It should be appreciated that the second module port 142B can be configured as the second intersecting port 142B₁ (FIG. 3A) or the second non-intersecting port 142B_{N} (FIG. 3B) depending on the module variant. It should be further appreciated that the fluidic modules 108 can comprise further module variants that differ with respect to the number of module ports 142, the number of intersecting ports, and/or the number of non-intersecting ports.

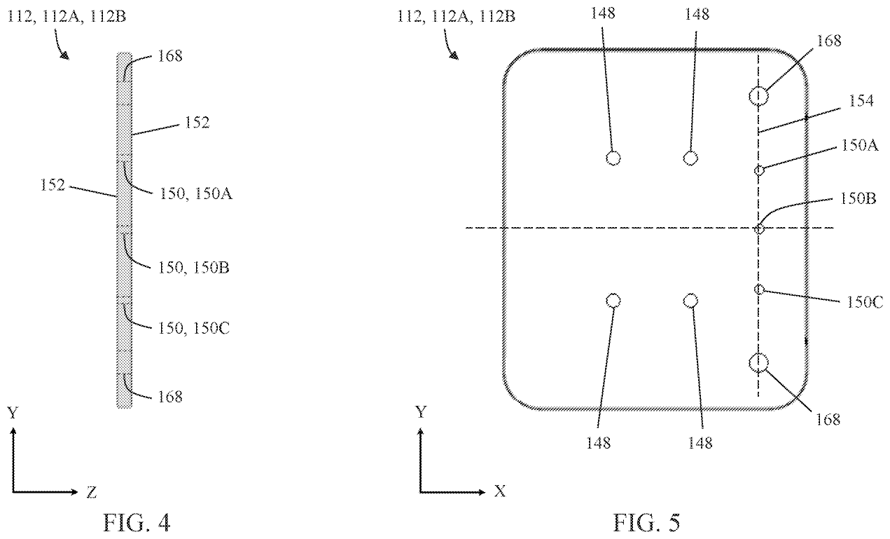

Referring now to FIG. 4 and FIG. 5 in connection with FIG. 1, aspects of the at least two metal plates 112 are shown. As shown in FIG. 1, the at least two metal plates 112 are supported by the frame 104. The fluidic modules 108 are arranged (e.g., sequentially) between the at least two metal plates 112 one by one in the first direction (e.g., the z-direction), which direction is substantially normal to the major outer surfaces 136 of the fluidic modules 108. In embodiments, the at least two metal plates 112 comprise a first metal plate 112A fixed to the frame 104 and a second metal plate 112B supported by the frame 104. In embodiments, the first metal plate 112A can be fixed (e.g., rigidly fixed) to the second support member 128 of the frame 104 by any fastening technique (e.g., mechanical fasteners, metal bonding/joining techniques, performance adhesives, etc.). As shown in FIG. 1 and FIG. 5, the first metal plate 112A can include mounting holes 148 and the second support member 128 can include mounting holes through which mechanical fasteners can be positioned and secured to fix the first metal plate 112A to the second support member 128 of the frame 104. As shown in FIG. 1, the fluidic modules 108 are arranged (e.g., sequentially) between the first metal plate 112A and the second metal plate 112B.

The first metal plate 112A and the second metal plate 112B each comprise a plurality of plate ports 150 that extend between opposed major plate surfaces 152 of each metal plate. The plate ports 150 of each of the first metal plate 112A and the second metal plate 112B can correspond in number and position to the module ports 142 of each of the fluidic modules 108 (e.g., adjacent fluidic modules) in embodiments. For example, when the fluidic modules 108 each include three module ports 142, as shown in FIGS. 2, 3A, and 3B, each of the first metal plate 112A and the second metal plate 112B can include three plate ports 150 positioned to correspond to the three module ports 142, respectively. In other words, between either of the first metal plate 112A and the second metal plate 112B and an adjacent fluidic module 108, each metal plate has a first plate port 150A that corresponds to the first module port 142A of the adjacent fluidic module, a second plate port 150B that corresponds to the second module port 142B of the adjacent fluidic module, and a third plate port 150C that corresponds to the third module port 142C of the adjacent fluidic module. The plate ports 150 can be aligned along a common line 154 that is oriented in the same direction as the common line 144 of the module ports 144 of each fluidic module 108. In embodiments, each of the plate ports 150 shares a common axis with a corresponding module port 142 while spaced part from the corresponding module port 142 along the first direction such that the plate ports 150 and the module ports 142 form corresponding pairs of ports adjacently spaced from one another in the first direction.

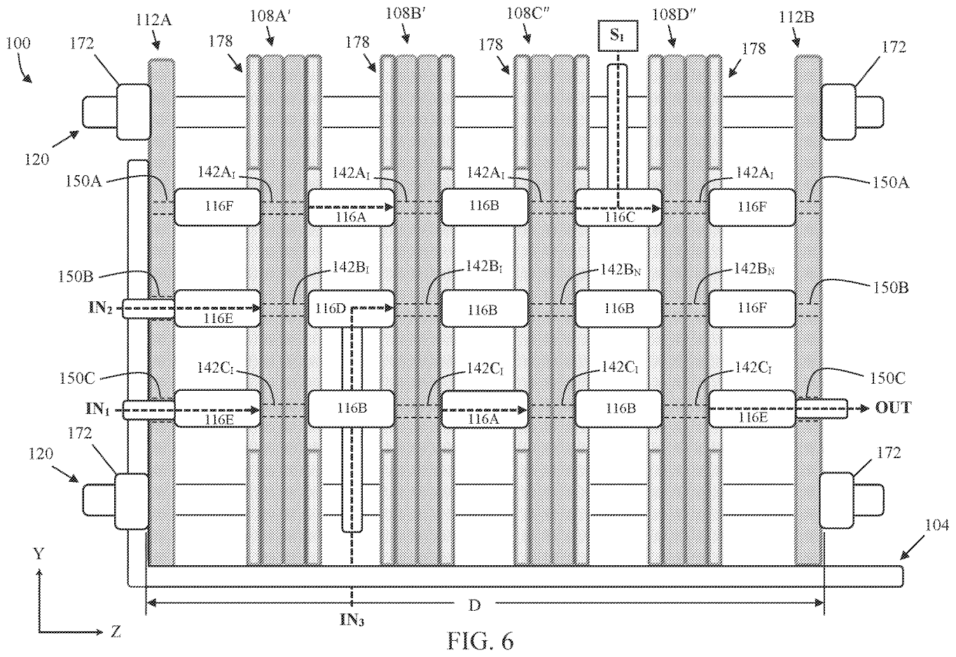

Referring now to FIG. 6 in connection with FIG. 1, further aspects of the fluidic modules 108, the metal inserts 116, and the at least two tightening members 120 are shown. FIG. 6 is a schematic diagram of a metal flow reactor, such as the metal flow reactor 100 of FIG. 1, with the fluidic modules 108 compressed against a first arrangement of the metal inserts 116 so as to define a process fluid flow through the metal flow reactor 100 according to a first process & instrumentation diagram (P&ID). For ease of description, a non-limiting naming convention is provided for reference to the different fluidic modules 108 associated with the metal flow reactor 100.

As viewed in FIG. 6, the left side of the metal flow reactor 100 can be considered an inlet side (e.g., two or more reactant materials can be introduced at the inlet side), and the right side of the metal flow reactor 100 can be considered an outlet side (e.g., product material(s) can be obtained from the outlet side). It should be appreciated that the inlet side and the outlet side can be reversed in embodiments. Since the fluidic modules 108 are arranged one by one in the first direction (e.g., the z-direction) between the first metal plate 112A and the second metal plate 112B, the fluidic modules 108 can be identified by their sequential position from the inlet side to the outlet side. For example, the fluidic module closest to the inlet side and adjacent to the first metal plate 112A can be a first fluidic module 108A, the next fluidic module in the first direction adjacent to the first fluidic module 108A can be a second fluidic module 108B, and so on such that the fluidic modules depicted in FIG. 6 include the first fluidic module 108A, the second fluidic module 108B, a third fluidic module 108C, and a fourth fluidic module 108D. Further with regard to the naming convention, the fluidic modules 108 are oriented such that one side of each fluidic module 108 is an inlet side 162 (FIG. 2) that faces towards the inlet side of the metal flow reactor 100 and the opposite side of each fluidic module 108 is an outlet side 164 (FIG. 2) that faces toward the outlet side of the metal flow reactor 100.

Referring still to FIG. 6, each metal insert 116 (any variant A, B, etc.) is configured to abut a corresponding pair of ports adjacently spaced in the first direction (e.g., the z-direction). For simplicity, the corresponding pair of ports are described only with respect to the second plate ports 150B and the second module ports 142B (e.g., configured as intersecting ports or non-intersecting ports). As described later in this disclosure, the corresponding pair of ports can also include the first plate ports 150A, the first module ports 142A (e.g., configured as intersecting ports or non-intersecting ports), the third plate ports 150C, and the third module ports 142C (e.g., configured as intersecting ports or non-intersecting ports). The corresponding pair of ports abutted by each metal insert 116 can comprise (i) two intersecting ports (e.g., the second intersecting port 142B₁ of the first fluidic module 108A′ and the second intersecting port 142B₁ of the second fluidic module 108B′), (ii) one intersecting port and one non-intersecting port (e.g., the second intersecting port 142B₁ of the second fluidic module 108B′ and the second non-intersecting port 142B_{N} of the third fluidic module 108C″), or (iii) one intersecting port and one plate port (e.g., the second intersecting port 142B₁ of the first fluidic module 108A′ and the second plate port 150B of the first metal plate 112A) such that every intersecting port of the metal flow reactor 100 is abutted by at least one metal insert 116.

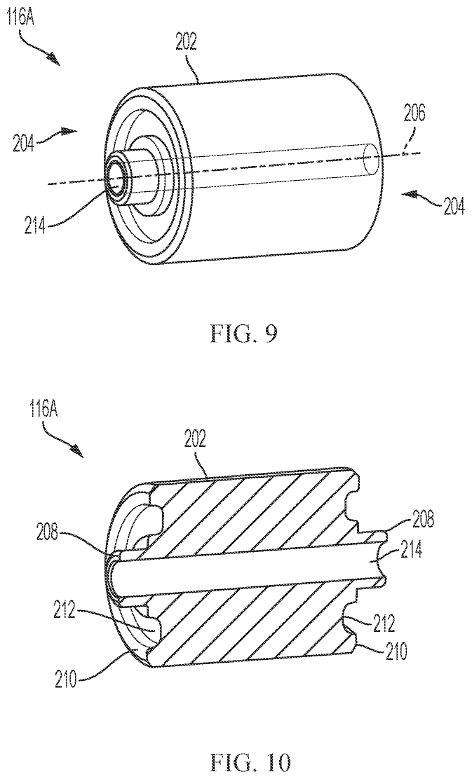

In embodiments, the corresponding pair of ports abutted by each metal insert 116 can optionally comprise (i) two non-intersecting ports (e.g., the second non-intersecting port 142B_{N} of the third fluidic module 108C″ and the second non-intersecting port 142B_{N} of the fourth fluidic module 108D″) or (ii) one non-intersecting port and one plate port (e.g., the second non-intersecting port 142B_{N} of the fourth fluidic module 108D″ and the second plate port 150B of the second metal plate 112B). The metal inserts 116 comprise different variants that are interchangeable within the metal flow reactor 100 and configured to enable different flow conditions between the corresponding pairs of ports. The different variants are described later in this disclosure with reference to FIGS. 9-19.

Referring still to FIG. 6 in connection with FIG. 1, the at least two tightening members 120 are configured to compress the at least two metal plates 112 (e.g., the first metal plate 112A and the second metal plate 112B) and the fluidic modules 108 (e.g., the first, second, third, and fourth fluidic modules 108A, 108B, 108C, and 108D) against the metal inserts 116 (any variant A, B, etc.). The at least two tightening members 120 extend in the first direction (e.g., the z-direction) through the at least two metal plates 112 and the fluidic modules 108. For example, the first metal plate 112A and the second metal plate 112B can each include through holes 168 (FIG. 4 and FIG. 5) configured with a clearance to allow the at least two tightening members 120 to pass therethrough. Similarly, the fluidic modules 108 can each include through holes 170 (FIGS. 2, 3A, and 3B) configured with a clearance to allow the at least two tightening members 120 to pass therethrough.

As shown in FIG. 6, each tightening member 120 is elongate in the first direction (e.g., the z-direction) and includes at least two contact portions 172 positioned at opposite ends thereof. The at least two contact portions 172 are configured to abut respective outer surfaces of the at least two metal plates 112. In embodiments, at least one contact portion 172 of each tightening member 120 is configured to adjust a distance D along the tightening member 120 in the first direction (e.g., the z-direction) between the at least two contact portions 172. For example, one contact portion 172 is configured to decrease and/or increase the distance D between the two contact portions 172 via actuation thereof to increase and/or decrease, respectively, the compression of the at least two metal plates 112 and the fluidic modules 108 against the metal inserts 116. In an exemplary embodiment, each tightening member 120 is configured as a threaded rod and at least one contact portion 172 of each tightening member 120 is configured as a threaded nut that engages the corresponding threaded rod. In embodiments, each contact portion 172 of each tightening member 120 is configured as a threaded nut that engages the threaded rod.

In embodiments in which the at least two tightening members 120 are configured as two threaded rods with corresponding threaded nuts, the threaded rods 120 can be configured to have a predetermined parallelism relative to one another. For example, the threaded rod 120 closest to the top side of the metal flow reactor 100 can have a top distance Dₜₒₚ between its corresponding threaded nuts 172, and the threaded rod closest to the bottom side of the metal flow reactor 100 can have a bottom distance D_{bottom} between its corresponding threaded nuts 172. The predetermined parallelism can be defined by the following equation:

$$\vert {D}_{top} - {D}_{bottom} \vert < 0.2 mm$$

In embodiments, the threaded nuts 172 are configured to be tightened to a predetermined torque. In embodiments, the predetermined torque is related to the total number of fluidic modules 108 in the metal flow reactor 100. For example, the predetermined torque can be from about 0.75 N·m to about 1.25 N·m per fluidic module 108. The predetermined torque for an example metal flow reactor comprising five fluidic modules 108 can be in a range of from about 3.75 N·m (e.g., 0.75×5) to about 6.25 Nm (e.g., 1.25×5). The predetermined torque for an example metal flow reactor comprising four fluidic modules 108 can be in a range of from about 3.00 Nm (e.g., 0.75×4) to about 5.00 N·m (e.g., 1.25×4). In embodiments, the predetermined torque range per fluidic module can be greater or lesser than from about 0.75 Nom to about 1.25 N·m per fluidic module. In embodiments, the threaded rods 120 have the predetermined parallelism and the threaded nuts 172 have the predetermined torque.

Referring to FIGS. 2, 3A, 3B, and 6, the at least two tightening members 120 are positioned relative to the module ports 142 so as to contain the working pressure in the fluidic passages of the fluidic modules 108. For example, when viewed in the first direction (e.g., the z-direction), the module ports 142 of each fluidic module 108 are positioned between the at least two tightening members 120. In embodiments, the at least two tightening members 120 are positioned symmetrically about the module ports 142 of each fluidic module 108. For example, as shown in FIG. 3A and FIG. 3B, the at least two tightening members 120 (e.g., the positions of which are indicated by the through holes 170) can be positioned symmetrically relative to a symmetry line 174 that bisects the module ports 142. In embodiments, the at least two tightening members 120 are aligned along the common line 144 along which the module ports 142 are aligned.

Referring still to FIGS. 2, 3A, 3B, and 6, one or more of the fluidic modules 108 can comprise a heat exchanger 178. Each heat exchanger 178 comprises two heat exchange layers 180 (FIG. 2) attached, respectively, to the major outer surfaces 136 of the metal reaction layer 134 of each of the one or more fluidic modules 108 to define heat exchange fluid passages 182 (FIG. 3A and FIG. 3B) therebetween. The heat exchange fluid passages 182 are configured to place heat exchange fluid in contact with the major outer surfaces 136 of the fluidic modules 108 and convey the heat exchange fluid along a path that coincides substantially with the fluid passages within the metal reaction layers 134 of each fluidic module 108.

As best shown in FIGS. 2, 3A, and 3B, each heat exchange layer 180 has a recessed portion 184 that delimits an exposed portion 186 of the major outer surface 136 that is not covered by the heat exchange layer 180. The module ports 142 of each of the one or more fluidic modules 108 are disposed within the exposed portion 186 so that the metal inserts 116 directly abut the module ports 142 and portions of the major outer surfaces 136 surrounding the module ports 142. As best shown in FIG. 2, the through boles 170 extend entirely through the heat exchange layers 180 so that the at least two tightening members 120 can pass freely through each heat exchanger 178. The through holes 170 and the exposed portions 186 enable the beat exchangers 178 to be decoupled from the compression applied to the fluidic modules 108, the at least two metal plates 112, and the metal inserts 116 via the at least two tightening members 120. This configuration can allow relaxation of the mechanical tolerances of the heat exchangers 178 and limits the effect of their expansion and/or contractions with temperature variations during operation of the metal flow reactor 100.

In embodiments, at least one adjacent pair of the fluidic modules 108 can include the heat exchangers 178 (e.g., the first fluidic module 108A′ and the second fluidic module 108B′ shown in FIG. 6). The metal inserts 116 disposed between the at least one adjacent pair of the fluidic modules 108 can be configured to provide a minimum gap between the heat exchangers 178 in the first direction (e.g., the z-direction). In an exemplary embodiment, the minimum gap is at least 1 mm. In embodiments, the two beat exchange layers 180 of each heat exchanger 178 are sealed, respectively, to the major outer surfaces 136 of the metal reaction layer 134 of each of the one or more fluidic modules 108. In such embodiments, the heat exchange layers 180 can be sealed via the same metal bonding or joining techniques used to join the two metal layers 140 of each metal reaction layer 134.

In embodiments, the two heat exchange layers 180 of each heat exchanger 178 can be fastened, respectively, to the major outer surfaces 136 of the metal reaction layer 134 of each of the one or more fluidic modules 108. For example, as shown in FIG. 3A and FIG. 3B, each heat exchange layer 180 comprises a plurality of mounting holes 188 disposed about a periphery of the heat exchange layer 180. The metal reaction layer 134 can comprise mounting holes (not shown) corresponding to the mounting holes 188 of the heat exchange layer 180 so that mechanical fasteners (not shown) can be used to attach the heat exchange layers 180 to the metal reaction layer 134. In embodiments, a gasket (not shown) can be positioned between the heat exchange layers 180 and the metal reaction layer 134 to improve sealing and heat transfer therebetween.

To account for potential differential thermal expansion/contraction between different components of the metal flow reactor 100 and reduce leakage potential (e.g., at the connections between adjacent fluidic modules 108), the metal reaction layer 134 of each fluidic module 108, the at least two metal plates 112, the metal inserts 116, and portions of the at least two tightening members 120 (e.g., the elongate portions) are formed from a same metal. In embodiments, the same metal comprises one of stainless steel, Hastelloy®, titanium, and tantalum. For categories of metal that include various grades and/or compositions within the same category (e.g., stainless steel includes 303 SS, 304 SS, etc.), it should be appreciated that the term “same metal” can also mean the same grade and/or the same composition of the indicated category or type of metal. For example, if the same metal is stainless steel, all of the noted components that are formed from the same metal would be formed from 303 SS or all of the noted components that are formed from the same metal would be formed from 304 SS. In embodiments, the contact portions 172 of the at least two tightening members 120 can be formed from a material different than the same metal. With such a configuration, when the temperature of the metal flow reactor 100 increases or decreases within operating limits, the different components that effect leakage potential are configured to have similar or substantially the same expansion or contraction, respectively, along the first direction such that no gap appears along the metal flow reactor 100. Such a configuration has enabled metal flow reactors 100 according to the present disclosure to operate with working pressure up to 50 bar or more and within a temperature range from about −60° C. to greater than 200° C. without leakage exceeding a predetermined value.

In embodiments in which the heat exchange layers 180 of each heat exchanger 178 are fastened to the metal reaction layer 134, the heat exchange layers 180 can be formed from a first metal that is different than the same metal from which the metal reaction layers 134, the at least two metal plates 112, the metal inserts 116, and the portions of the at least two tightening members 120 are formed. In such embodiments, the first metal can be aluminum, which is lower cost than the same metal.

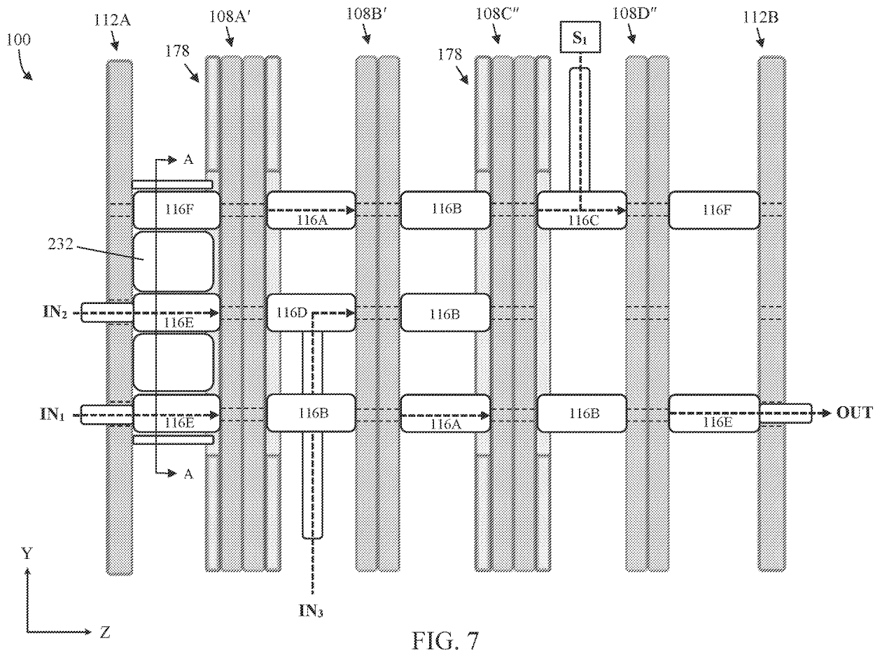

Referring now to FIG. 7, the metal flow reactor 100 is shown with a different arrangement of the heat exchangers 178. FIG. 7 is a simplified schematic diagram of the metal flow reactor 100 of FIG. 6 with heat exchangers 178 omitted from some of the fluidic modules 108 according to embodiments. FIG. 7 is simplified relative to FIG. 6 in that the frame 104 and the at least two tightening member 120 are omitted from the view of FIG. 7 and the module ports 142 and the plate ports 150 are not labeled in FIG. 7 to improve clarity. In particular, as shown in FIG. 7, the first fluidic module 108A′ and the third fluidic module 108C″ include heat exchangers 178 whereas the second fluidic module 108B′ and the fourth fluidic module 108D″ do not include heat exchangers 178. Such modularity with regard to heat exchangers 178 enables intricate customization of heat zones within the metal flow reactor 100.

FIG. 7 also shows the metal flow reactor 100 with optional metal inserts removed. As described above, the corresponding pair of ports abutted by each metal insert 116 can optionally comprise (i) two non-intersecting ports or (ii) one non-intersecting port and one plate port. The metal flow reactor 100 of FIG. 6 included these optional metal inserts 116. For example, the metal flow reactor 100 of FIG. 6 included (i) an optional metal insert 116 between (i) the second non-intersecting port 142B_{N} of the third fluidic module 108C″ and the second non-intersecting port 142B_{N} of the fourth fluidic module 108D″ and (ii) an optional metal insert 116 between the second non-intersecting port 142B_{N} of the fourth fluidic module 108D″ and the second plate port 150B of the second metal plate 112B. In contrast, FIG. 7 does not include these optional metal inserts 116 at the noted corresponding pairs of ports. The omission of such optional metal inserts can save costs and simplify assembly/disassembly of the metal flow reactor 100.

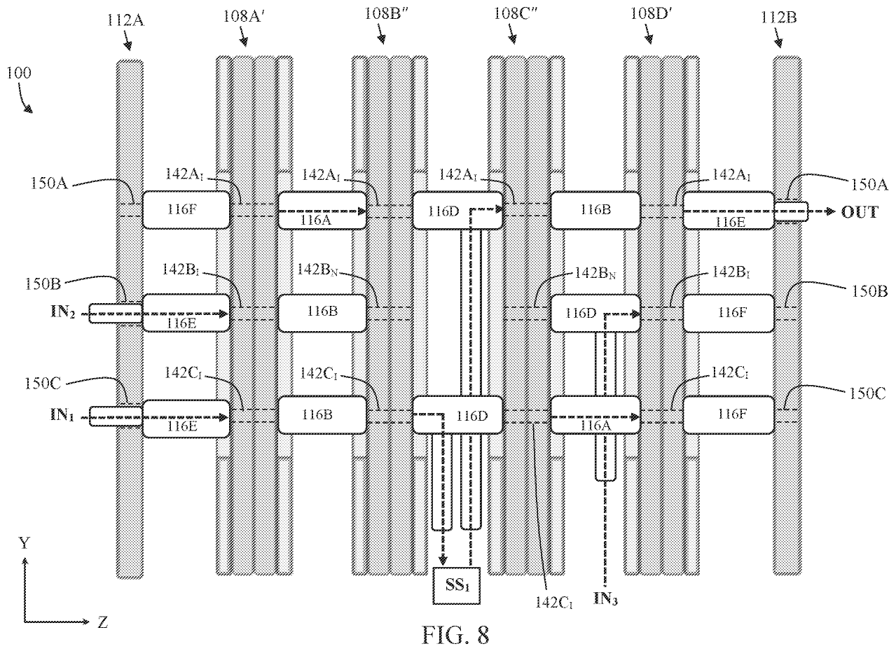

FIG. 8 is a simplified schematic diagram of the metal flow reactor 100 of FIG. 6 with the fluidic modules 108 compressed against a second arrangement of the metal inserts 116 that is different than the first arrangement of metal inserts 116 so as to define a process fluid flow through the reactor according to a second P&ID that is different than the first P&ID. FIG. 8 is simplified relative to FIG. 6 in that the frame 104 and the at least two tightening member 120 are omitted from the view of FIG. 8 to improve clarity. As described above, the metal inserts 116 comprise different variants that are interchangeable within the metal flow reactor 100 and configured to enable different flow conditions between the corresponding pairs of ports. The first arrangement of the metal inserts 116 (FIG. 6 and FIG. 7), the second arrangement of the metal inserts 116 (FIG. 8), and any further arrangements of the metal inserts 116 are formed by combining the different variants in different arrangements.

FIGS. 9-19 illustrate further details of the metal inserts 116, including common or substantially similar features among the different variants of the metal inserts 116. As shown in FIGS. 9-19, each metal insert 116 comprises a first body portion 202 that is monolithic and extends between opposed end faces 204 thereof along a central axis oriented substantially parallel to the first direction (e.g., the z-direction). The first body portion 202 is elongate in the first direction and has a cylindrical shape when viewed in a cross section oriented substantially normal to the first direction.

Referring still to FIGS. 9-19, each end face 204 of each metal insert 116 has a protrusion 208 that extends therefrom. The protrusions are configured to be received in the corresponding pair of ports (e.g., the module ports 142 and/or the plate ports 150) abutted by the metal insert 116. In embodiments, the protrusions 208 and the ports 142, 150 have respective sizes configured to enable a relatively small gap therebetween so that the protrusions 208 enable the metal inserts 116 to be self-centered within the ports 142, 150. In embodiments, the gap or clearance between the protrusions 208 and the ports 142, 150 is approximately 0.2 mm, for example, in a range from about 0.15 mm to about 0.25 mm. In embodiments, the protrusions 208 of each metal insert 116 are arranged concentrically with respect to the central axis 206 of the first body portion 202.

Referring still to FIGS. 9-19, each end face 204 of each metal insert 116 has a surface portion 210 oriented substantially normal to the first direction (e.g., the z-direction). Each surface portion 2010 of each metal insert 116 is configured to abut one or more of the major outer surface 136 proximate each module port 142 (e.g., configured as an intersecting port or a non-intersecting port) and the major plate surface 152 proximate each plate port 150. As shown in FIGS. 9-19, each end face 204 of each metal insert 116 has a groove 212 configured to receive a gasket or O-ring (not shown). The gasket is configured to be compressed between the end face 204 and the one or more of the major outer surface 136 proximate each module port 142 and the major plate surface 152 proximate each plate port 150, and surround the port 142, 150 abutted by the metal insert 116. As shown in FIGS. 9-19, the grooves 212 of each metal insert 116 are arranged concentrically with respect to the central axis 206 of the first body portion 202. In embodiments in which the metal insert 116 abuts a plate port 150 or a module port 142 configured as a non-intersecting port (e.g., the module port 142 does not intersect the fluid passage 138), the gasket or O-ring can be omitted from the corresponding end face 204 of the metal insert 116.

FIG. 9 and FIG. 10 depict one metal insert variant in which the metal inserts 116 comprise first inserts 116A (also referred to as “through inserts”) configured to interchangeably abut the corresponding pairs of ports. Each first insert 116A is configured to a set a first flow condition in which the ports of the corresponding pair of ports are fluidically connected to one another. As shown in FIG. 9 and FIG. 10, the first body portion 202 of each first insert 116A defines a first fluid passage 214 that extends through the first insert 116A and fluidically connects the corresponding pair of ports abutted by the first insert 116A. In embodiments, the first fluid passage 214 is arranged concentrically with respect to the central axis 206 of the first body portion 202.

FIG. 11 and FIG. 12 illustrate another metal insert variant in which the metal inserts 116 comprise second inserts 116B (also referred to as “plug inserts”) configured to interchangeably abut the corresponding pairs of ports. Each second insert 116B is configured to set a second flow condition in which the ports of the corresponding pair of ports are fluidically isolated from one another. As shown in FIG. 11 and FIG. 12, the first body portion 202 of each second insert 116B is configured to be impervious to fluid so as to fluidically isolate the corresponding pair of ports abutted by the second insert 116B. For example, the first body portion 202 does not contain any passages, channels, or connected porosity that would enable fluid to traverse between the opposed end faces 204 of the second inserts 116B.

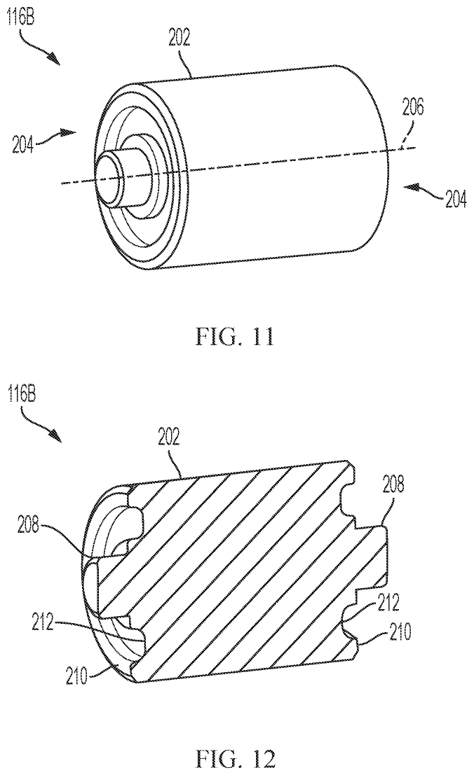

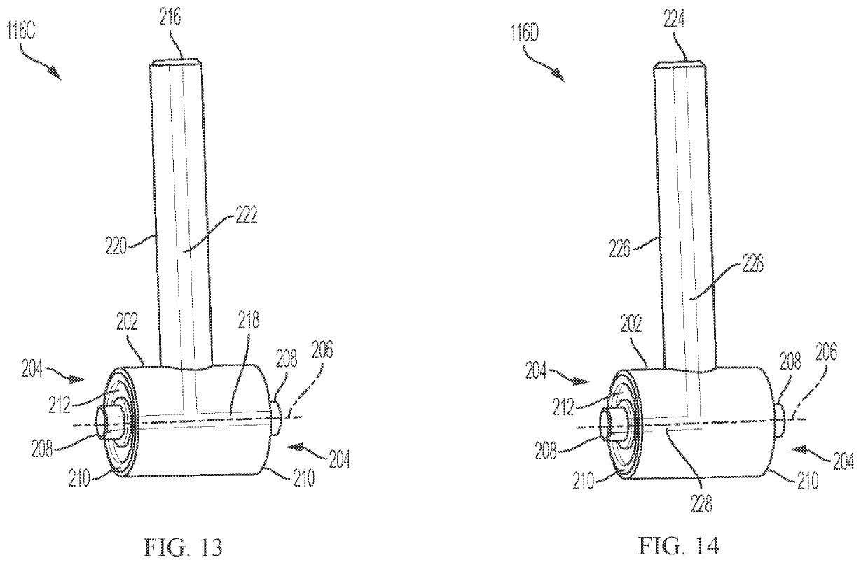

FIG. 13 shows another metal insert variant in which the metal inserts 116 comprise third inserts 116C (also referred to as “sensing through inserts”) configured to interchangeably abut the corresponding pairs of ports. Each third insert 116C is configured to set a third flow condition in which the ports of the corresponding pair of ports are fluidically connected to one another and to a first port 216. As shown in FIG. 13, the first body portion 202 of each third insert 116C defines a second fluid passage 218 that extends through the third insert 116C and fluidically connects the corresponding pair of ports abutted by the third insert 116C. Each third insert 116C also has a second body portion 220 that extends transversely from the first body portion 202. The second body portion defines a third fluid passage 222 fluidically connected to the second fluid passage 218 at one end and the first port 216 at an opposite end. The third inserts 116C enable integrated measurement points along the process fluid flow through the metal flow reactor 100 via sensors (e.g., pressure, flowrate, temperature, chemistry online analysis, etc.) connected to the first port 216 of the third insert 116C.

FIG. 14 shows another metal insert variant in which the metal inserts 116 comprise fourth inserts 116D (also referred to as “intermediary inserts”) configured to interchangeably abut the corresponding pairs of ports. Each fourth insert 116D is configured to set a fourth flow condition in which (i) the ports of the corresponding pair of ports are fluidically isolated from one another and (ii) one port of the corresponding pair of ports is fluidically connected to a second port 224. As shown in FIG. 14, each fourth insert 116D has a third body portion 226 that extends transversely from the first body portion 202. The first body portion 202 and the third body portion 226 define a fourth fluid passage 228 fluidically connected to the one port of the corresponding pair of ports and the second port 224. In embodiments, the fourth inserts 116D enable additional fluids to be added to the process fluid flow downstream from the inlet side of the metal flow reactor 100. In such embodiments, the additional fluids can be delivered to the second port 224 via flexible metal piping (not shown) to account for expansion/contraction of the stack of fluidic modules under changing temperature conditions during operation of the metal flow reactor 100.

In embodiments, the fourth inserts 116D also enable integration of a serial sensors. For example, a serial sensor can be fluidically connected in series to the second ports 224 of two fourth inserts 116D positioned between adjacent fluidic modules 108. One of the two fourth inserts 116D is positioned upstream from the serial sensor and fluidically connected to the module port 142 discharging the process fluidic flow from the adjacent upstream fluidic module. The other of the two fourth inserts 116C is positioned downstream from the serial sensor and fluidically connected to the module port 142 receiving the process fluid flow into the adjacent downstream fluidic module 108.

The first inserts 116A, the second inserts 116B, the third inserts 116C, and the fourth inserts 116D are each configured to abut the corresponding pair of ports comprising (i) two intersecting ports or (ii) one intersecting port and one non-intersecting port. Further variants of the metal inserts 116 can be used when the corresponding pair of ports comprises at least one plate port, such as when the corresponding pair of ports comprises (i) one intersecting port and one plate port or (ii) one non-intersecting port and one plate port.

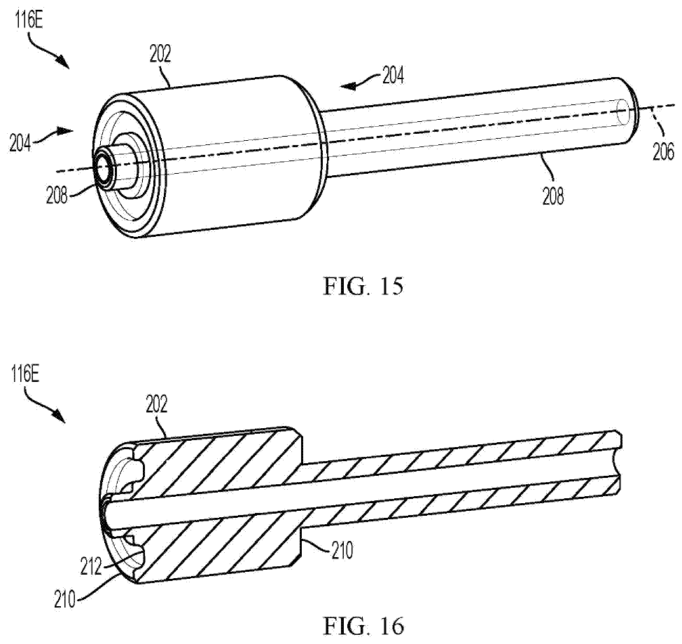

FIG. 15 and FIG. 16 illustrate one further metal insert variant in which the metal inserts 116 comprise fifth inserts 116E (also referred to as “end through inserts”) configured to interchangeably abut the corresponding pairs of ports that comprise at least one plate port 150. Each fifth insert 116E is configured to set a fifth flow condition in which the ports of the corresponding pair of ports that comprise at least one plate port are fluidically connected to one another. As illustrated by comparing FIG. 9 and FIG. 10 with FIG. 15 and FIG. 16, the fifth inserts 116E are similar to the first inserts 116A except with regard to one of the protrusions and one of the grooves. In embodiments, the protrusions 208 of each fifth insert 116E have different lengths in the first direction. For example, the protrusion 208′ configured to be received in the plate port 150 is longer in the first direction than the protrusion 208 configured to be received in the module port 142 (e.g., the one intersecting port or the one non-intersecting port). In embodiments, the end face 204 on the side of the fifth insert 116E adjacent to the longer protrusion 208′ does not have a groove or a gasket. Instead, the end face only has the surface portion. In embodiments, flexible metal piping (not shown) can be used for fluidic connection to the longer protrusion 208′ to enable delivery or discharge of the process fluid flow to/from the metal flow reactor 100. The flexible metal piping is configured to account for expansion/contraction of the stack of fluidic modules under changing temperature conditions during operation of the metal flow reactor 100.

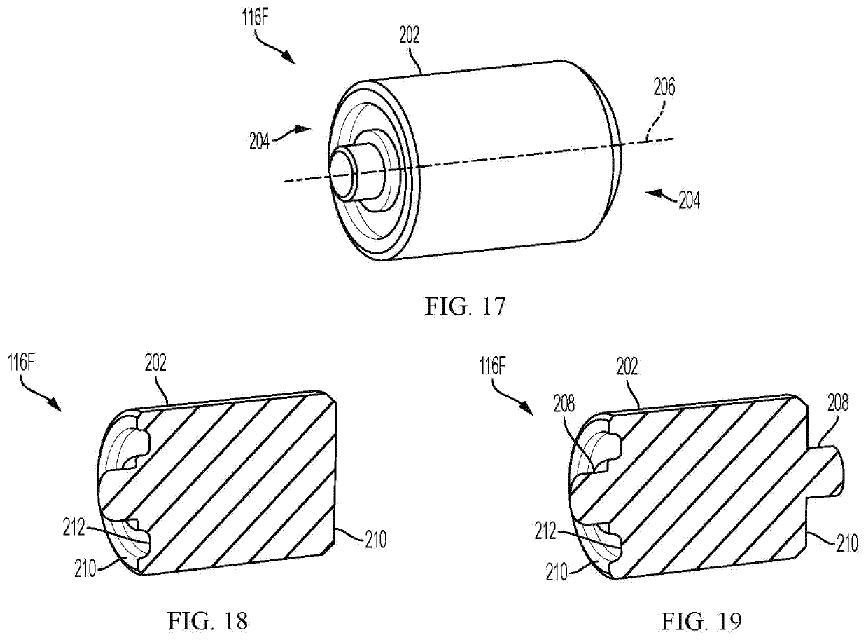

FIGS. 17-19 illustrate another further metal insert variant in which the metal inserts 116 comprise sixth inserts 116F (also referred to as “end plug inserts”) configured to interchangeably abut the corresponding pairs of ports that comprise at least one plate port. Each sixth insert 116F is configured to set a sixth flow condition in which the ports of the corresponding pair of ports that comprise at least one plate port are fluidically isolated from one another. As illustrated by comparing FIG. 11 and FIG. 12 with FIGS. 17-19, the sixth inserts 116F are similar to the second inserts 116B except with regard to one of the grooves and, optionally, one of the protrusions. For example, the end face 204 on the side of the sixth insert 116F adjacent to the plate port 150 does not have a groove or a gasket. In an optional embodiment, the end face 204 adjacent to the plate port 150 also does not have a protrusion.

Referring again to FIG. 6 and FIG. 8, the fluidic modules 108 and the metal inserts 116 are shown in different arrangements to illustrate the modularity of the metal flow reactor 100 and its corresponding process & instrumentation diagram (P&ID). FIG. 6 depicts the metal flow reactor 100 with a reactor stack comprising the first metal plate 112A, a first fluidic module 108A′ (first module variant), a second fluidic module 108B′ (first module variant), a third fluidic module 108C″ (second module variant), a fourth fluidic module 108D″ (second module variant), and the second metal plate 112B. The process fluid flow through the metal flow reactor 100 of FIG. 6 is depicted by multiple arrows shown in bolded, dashed line type and passing through the metal inserts configured to permit the corresponding fluid flow therethrough. The metal flow reactor 100 of FIG. 6 includes three fluid inlets IN₁, IN₂, IN₃, one sensor input S₁, and one fluid outlet OUT, which are shown associated with the metal inserts 116 that provide the corresponding functionality via the process fluid flow arrows proximate thereto.

Referring still to FIG. 6, the metal inserts configured to abut corresponding pairs of ports adjacently spaced between the first metal plate 112A and the first fluidic module 108A′ include: (i) a sixth insert 116F (end plug insert) that abuts the first plate port 150A and the first intersecting port 142A₁, (ii) a fifth insert 116E (end through insert) that abuts the second plate port 150B and the second intersecting port 142B₁, and (iii) a fifth insert 116E (end through insert) that abuts the third plate port 150C and the third intersecting port 142C₁. The metal inserts configured to abut corresponding pairs of ports adjacently spaced between the first fluidic module 108A′ and the second fluidic module 108B′ include: (i) a first insert 116A (through insert) that abuts the two first intersecting ports 142A₁, (ii) a fourth insert 116D (intermediary insert) that abuts the two second intersecting ports 142B₁, and (iii) a second insert 116B (plug insert) that abuts the two third intersecting ports 142C₁.

Referring still to FIG. 6, the metal inserts configured to abut corresponding pairs of ports adjacently spaced between the second fluidic module 108B′ and the third fluidic module 108C″ include: (i) a second insert 116B (plug insert) that abuts the two first intersecting ports 142A₁, (ii) a second insert 116B (plug insert) that abuts the second intersecting port 142A₁ and the second non-intersecting port 142B_{N}, and (iii) a first insert 116A (through insert) that abuts the two third intersecting ports 142C₁. The metal inserts configured to abut corresponding pairs of ports adjacently spaced between the third fluidic module 108C″ and the fourth fluidic module 108D″ include: (i) a third insert 116C (sensing through insert) that abuts the two first intersecting ports 142A₁, (ii) optionally a second insert 116B (plug insert) that abuts the two second non-intersecting ports 142B_{N}, and (iii) a second insert 116B (plug insert) that abuts the two third intersecting ports 142C₁. The metal inserts configured to abut corresponding pairs of ports adjacently spaced between the fourth fluidic module 108D″ and the second metal plate 112B include: (i) a sixth insert 116F (end plug insert) that abuts the first intersecting port 142A₁ and the first plate port 150A, (ii) optionally a sixth insert 116F (end plug insert) that abuts the second non-intersecting port 142B_{N} and the second plate port 150B, and (iii) a fifth insert 116E (end through insert) that abuts the third intersecting port 142C₁ and the third plate port 150C.

FIG. 8 depicts the metal flow reactor 100 with a reactor stack comprising the first metal plate 112A, a first fluidic module 108A′ (first module variant), a second fluidic module 108B″ (second module variant), a third fluidic module 108C″ (second module variant), a fourth fluidic module 108D′ (first module variant), and the second metal plate 112B. The process fluid flow through the metal flow reactor 100 of FIG. 8 is depicted by multiple arrows shown in bolded, dashed line type and passing through the metal inserts configured to permit the corresponding fluid flow therethrough. The metal flow reactor 100 of FIG. 8 includes three fluid inlets IN₁, IN₂, IN₃, one serial sensor input SS₁, and one fluid outlet OUT, which are shown associated with the metal inserts 116 that provide the corresponding functionality via the process fluid flow arrows proximate thereto.

Referring still to FIG. 8, the metal inserts configured to abut corresponding pairs of ports adjacently spaced between the first metal plate 112A and the first fluidic module 108A′ include: (i) a sixth insert 116F (end plug insert) that abuts the first plate port 150A and the first intersecting port 142A₁, (ii) a fifth insert 116E (end through insert) that abuts the second plate port 150B and the second intersecting port 142B₁, and (iii) a fifth insert 116E (end through insert) that abuts the third plate port 150C and the third intersecting port 142C₁. The metal inserts configured to abut corresponding pairs of ports adjacently spaced between the first fluidic module 108A′ and the second fluidic module 108B″ include: (i) a first insert 116A (through insert) that abuts the two first intersecting ports 142A₁, (ii) a second insert 116B (plug insert) that abuts the second intersecting port 142B₁ and the second non-intersecting port 142B_{N}, and (iii) a second insert 116B (plug insert) that abuts the two third intersecting ports 142C₁.

Referring still to FIG. 8, the metal inserts configured to abut corresponding pairs of ports adjacently spaced between the second fluidic module 108B″ and the third fluidic module 108C″ include: (i) a fourth insert 116D (intermediary insert) that abuts the two first intersecting ports 142A₁, and (ii) a fourth insert 116D (intermediary insert) that abuts the two third intersecting ports 142C₁. In the embodiment shown, there is no metal insert that abuts the two second non-intersecting ports 142B_{N} between the second fluidic module 108B″ and the third fluidic module 108C″ though, optionally, a second insert 116B (plug insert) could be positioned at that position in other embodiments. The metal inserts configured to abut corresponding pairs of ports adjacently spaced between the third fluidic module 108C″ and the fourth fluidic module 108D′ include: (i) a second insert 116B (plug insert) that abuts the two first intersecting ports 142A₁, (ii) a fourth insert 116D (intermediary insert) that abuts the second non-intersecting port 142B_{N} and the second intersecting port 142B₁, and (iii) a first insert 116A (through insert) that abuts the two third intersecting ports 142C₁. The metal inserts configured to abut corresponding pairs of ports adjacently spaced between the fourth fluidic module 108D′ and the second metal plate 112B include: (i) a fifth insert 116E (end through insert) that abuts the first intersecting port 142A₁ and the first plate port 150A, (ii) a sixth insert 116F (end plug insert) that abuts the second intersecting port 142B₁ and the second plate port 150B, and (iii) a sixth insert 116F (end plug insert) that abuts the third intersecting port 142C₁ and the third plate port 150C.

Referring again to FIG. 6 and FIG. 8, the reconfigurable P&ID is enabled by the modularity of the metal flow reactor 100 via disassembly/assembly of the different fluidic modules 108 and the different metal inserts 116. It should be appreciated that numerous other P&ID configurations are enabled by adjusting the number of fluidic modules included in the metal flow reactor, selecting the desired metal insert variants, and attaching heat exchangers to select or all fluidic modules within the metal flow reactor.

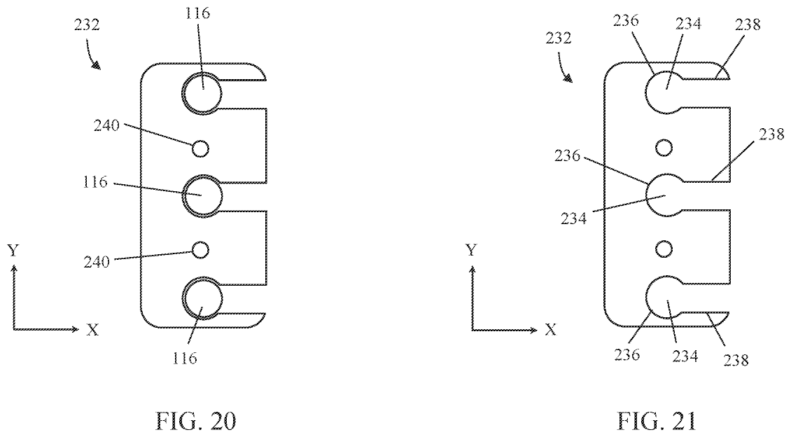

Referring now to FIG. 20 and FIG. 21 in connection with FIG. 1 and FIG. 7, the metal flow reactor 100 includes one or more spacers 232 configured to position the metal inserts 116 relative to the at least two plates 112 and/or the fluidic modules 108. FIG. 20 is a section cut through an exemplary spacer 232 along line A-A shown in FIG. 7, showing three metal inserts 116 supported by the spacer 232. FIG. 21 shows the spacer 232 of FIG. 20 with the three metal inserts 116 removed for clarity. As shown in FIG. 20 and FIG. 21, each spacer 232 defines a plurality of openings 234 that extend through the spacer in the first direction (e.g., the z-direction). Each opening 234 is configured to receive one of the metal inserts 116 and align the metal insert 116 with the ports 142, 150 abutted by the metal insert 116. In embodiments, the spacers 232 can be formed from a metal (e.g., the same metal as the metal inserts 116) though different materials can also be used, such as polymers adapted to the range of operating temperatures of the metal flow reactor 100.

Referring again to FIG. 7, the metal inserts 116 each have an insert length in the first direction (e.g., the z-direction) and the spacers 232 each have a spacer thickness in the first direction. The insert length is greater than the spacer thickness. Such a difference between the insert length and the spacer thickness is illustrated in FIG. 7 by comparison of the three metal inserts 116 and the spacer 232 between the first metal plate 112A and the first fluidic module 108A. As shown in FIG. 1 and FIG. 7, the spacer 232 is shorter in the first direction than the three metal inserts 116. In embodiments, the difference between the insert length and the spacer thickness is in a range of from about 0.05 mm to about 0.15 mm. Each spacer 232 is positioned proximate to or against the major outer surface 136 of one of each adjacent pair of fluidic modules in the metal flow reactor. When positioned between one of the at least two metal plates and an adjacent fluidic module, the spacer 232 can be positioned proximate to or against the major outer surface 136 of the adjacent fluidic module or the major plate surface 152 of the one of the at least two metal plates. In embodiments, the spacer 232 is positioned relative to the recessed portion 184 of an adjacent heat exchanger 178 and proximate to or against the exposed portion 186 of the major outer surface 136. In embodiments, the spacer 232 can be positioned proximate to the major outer surfaces 136 with mechanical fasteners or similar fastening means.

Referring again FIG. 21, each opening 234 of each spacer 232 comprises (i) an insert portion 236 configured to receive and align a respective metal insert 116 and (ii) a slot portion 238 that extends from the insert portion 236 in a second direction (e.g., the x-direction) orthogonal to the first direction and opens to a side of the spacer 232. In embodiments, the largest dimension of the insert portion 236 in a third direction (e.g., the y-direction) orthogonal to the first and second directions is greater than the largest dimension of the slot portion 238 in the third direction such that the respective metal insert 116 positioned therein cannot pass through the slot portion 238.

The spacers 232 can be useful during assembly/disassembly of the metal flow reactor 100. For example, a method of assembling the metal flow reactor 100 can include using the spacers 232 to hold/position the inserts while each metal plate 112 and each fluidic module is initially positioned on or removed from the frame 104. For example, starting with only the frame 104, the first metal plate 112A can be positioned on the frame 104 and fixed to the second support member 128 via fasteners. Next, a first spacer 232 can be positioned proximate to the major plate surface 152 of the first metal plate 112A (e.g., via fasteners positioned through mounting holes 240 in the spacer 232) so that the openings 234 of the first spacer 232 are concentric with the plate ports 150 of the first metal plate 112A.

Thereafter, the metal inserts 116 selected to define the desired P&ID of the metal flow reactor 100 are inserted into the openings 234 of the first spacer 232. It should be appreciated that the metal inserts 116 can be inserted into the openings 234 of the first spacer 232 before the first spacer 232 is positioned proximate to the major plate surface 152 of the first metal plate 112A. Next, the first fluidic module 108A can be positioned on the frame adjacent to the first metal plate 112A. During the positioning of the first fluidic module 108A, care is taken to ensure the protrusions 208 of each metal insert 116 are aligned with the module ports 142 of the first fluidic module 108A and then the first fluidic module 108A is pushed towards the first metal plate 112A until the metal inserts 116 abut the corresponding pairs of ports between the first metal plate 112A and the first fluidic module 108A.

Once the first fluidic module 108A is pushed against the metal inserts 116, a second spacer 232 can be positioned proximate to the major outer surface 136 on the opposite side (e.g., the outlet side 164) of the first fluidic module 108A so that the openings 234 of the second spacer 232 are concentric with the module ports 142 of the first fluidic module 108A. Thereafter, the metal inserts 116 selected to define the desired P&ID of the metal flow reactor 100 are inserted into the openings 234 of the second spacer 232. Next, the second fluidic module 108B can be positioned on the frame adjacent to the first fluidic module 108A. During the positioning of the second fluidic module 108B, care is taken to ensure the protrusions 208 of each metal insert 116 are aligned with the module ports 142 of the second fluidic module 108B and then the second fluidic module 108A is pushed towards the first fluidic module 108A until the metal inserts 116 abut the corresponding pairs of ports between the first fluidic module 108A and the second fluidic module 108B.

This procedure is repeated for each additional fluidic module added to the metal flow reactor 100 until the second metal plate 112B is pushed against the metal inserts 116 between the last fluidic module in the stack and the second metal plate 112B. Once the second metal plate 112B is pushed against the metal inserts, the at least two tightening members 120 (e.g., the threaded rods) are inserted through the first metal plate 112A, the fluidic modules 108 (including any heat exchangers positioned thereon), and the second metal plate 112B. The contact portions 172 (e.g., the threaded nuts) are then tightened progressively until achieving the predetermined torque.

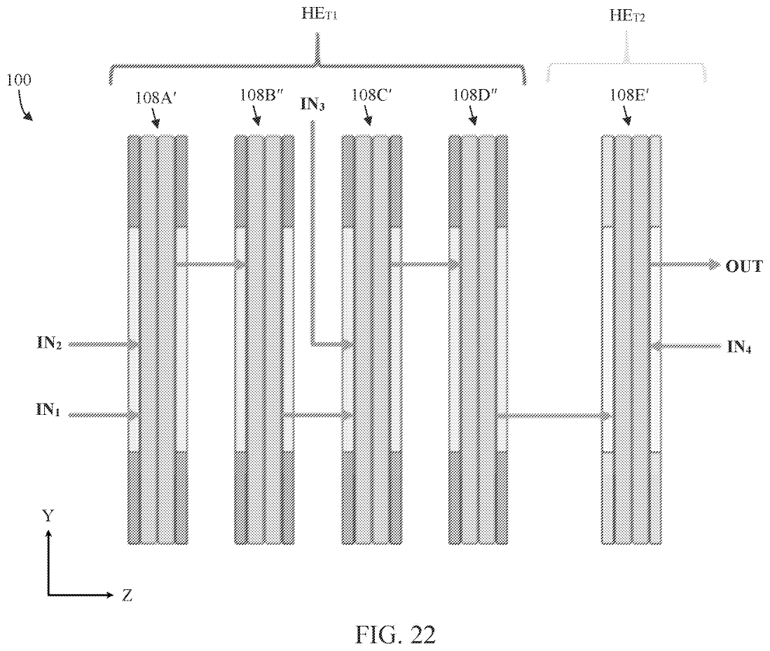

FIG. 22 is a simplified schematic diagram of a metal flow reactor 100 with metal fluidic modules 108 having individually controllable heat exchangers 178 configured to provide at least two different heating zones. The metal flow reactor 100 has a reactor stack comprising a first fluidic module 108A′ (first module variant), a second fluidic module 108B″ (second module variant), a third fluidic module 108C′ (first module variant), a fourth fluidic module 108D″ (second module variant), and a fifth fluidic module 108C′ (first module variant). The process fluid flow through the metal flow reactor 100 of FIG. 22 is depicted by multiple arrows shown in bolded line type. The metal flow reactor 100 of FIG. 22 includes four fluid inlets IN₁, IN₂, IN₃, IN₄ and one fluid outlet OUT, which (for simplicity) are shown without the metal inserts 116 that provide the corresponding functionality. As shown in FIG. 22, the metal flow reactor 100 of comprise a first zone HE_{T1} configured to thermalize the reaction and second zone HE_{T2} to stop the reaction, for example, with lower temperature.

### Examples

Various embodiments of the present disclosure can be better understood by reference to the following Examples which are offered by way of illustration. The present disclosure is not limited to the Examples given herein.

A metal flow reactor comprising 5 fluidic modules was assembled according to the principles of the disclosure. The metal flow reactor was tested with maximal thermodynamical constraints where the boundary conditions were applied (e.g., up to 200° C. and up to 50 bars). At least two different gaskets were trialed. Air was used as the test fluid and leakage was measured with a requirement for pressure loss to remain <0.2 bar per 10 minutes of hold time. Two heating zone configurations were used during tests: (1) one configuration in which the metal flow reactor was configured to have a single temperature zone (“Single Zone”) and (2) one configuration in which the metal flow reactor was configured to have two temperature zones (“Two Zone”).

TABLE 1
Single Zone - Air Leakage at Fixed Temperature Increments

| leakage test | RT | +80° C. | +140° C. | +200° C. | RT |
|---|---|---|---|---|---|
| 18 bar | | ok | ok | ok | ok |
| 34 bar | | ok | ok | −0.04 | |
| 50 bar | −0.06 | −0.04 | −0.09 | −0.12 | −0.15 |

TABLE 2
Single Zone - Air Leakage after Repeated Thermal Cycles

| leakage test | RT | +200° C. | RT | +200° C. | RT | +200° C. | RT | +200° C. | RT | +200° C. | RT |
|---|---|---|---|---|---|---|---|---|---|---|---|
| 18 bar | | | | | | | | | | | |
| 34 bar | | | | | | | | | | | |
| 50 bar | −0.13 | −0.08 | −0.08 | −0.09 | −0.08 | x | x | x | x | −0.05 | −0.08 |

TABLE 3
Two Zone - Air Leakage at Fixed Temperature Increments

| leakage | | +110° C./ | +160° C./ | +200° C./ | |
|---|---|---|---|---|---|
| test | RT | +10° C. | +10° C. | +10° C. | RT |
| 50 bar | −0.08 | −0.14 | −0.12 | −0.11 | −0.15 |

For both heating zone configurations (Single Zone and Two Zone), the test results indicate good reliability against air leakage. No issues were observed during testing of the Single Zone configurations (Table 1 and Table 2). For example, according to Table 1, no issues were observed while the metal flow reactor was subjected to temperatures of room temperature (“RT” @ 20° C.), +80° C., +140° C., and +200° C. and pressures of 18 bar, 34 bar, and 50 bar. Similarly, according to Table 2, no issues were observed while the metal flow reactor was subjected to temperature cycling between room temperature and +200° C., five times, and pressure of 50 bar. No issues were observed during testing of the Two Zone configuration (Table 3). For example, according to Table 3, no issues were observed while the metal flow reactor was subjected zone/zone temperatures of RT/RT, +110° C./+10° C., +160° C./+10° C., +200° C./+10° C., and RT/RT and a pressure of 50 bar.

The metal flow reactor embodiments disclosed herein have numerous advantages. In particular, the mechanical architecture enable significant modularity of: (i) reactor material (with different metal choices: stainless steel, Hastelloy, Titanium, Tantalum, and others); (ii) fluidic module geometry, including the option to have only module reaction layers (e.g., no heat exchange layers), 4 layers with heat exchange layers integrated by sealing/fastening on the module reaction layers, or mixed fluidic modules with and without heat exchange layers with unchanged mechanical architecture; (iii) fluidic channel arrangement, for example, the possibility to quickly change the P&ID of reactor and/or the possibility to have additional fluid inlets between fluidic modules; (iv) temperature management with the possibility to have several fluid temperature zones along the reactor.

The metal flow reactor embodiments disclosed herein also: (i) simplify the reactor mounting (few variants of mechanical parts) and provided simplified and localized clamping around pressurization point at the module ports, which allows reliable operation up to 200° C. and 50 bars; (ii) simplify the positioning of connections by the design of metal inserts that are self-centered and limit the dead zones (which should be avoided with some chemistries); (iii) have large mechanical tolerances on a large portions of mechanical part machining; (iv) integrate the opportunity to have measurement points along the fluidic channel to connect sensors (pressure sensor, flowrate, thermocouple, chemistry online analysis, etc.); (v) optimize the thermal management with insulation box integration (e.g., helps avoid thermal losses) and increase user safety with such an insulation box (e.g., avoid potential projections from the reactor if an issue appears); and (vi) reduces mechanical architecture cost compared to conventional reactor architecture.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A flow reactor, comprising:
a frame;
a plurality of fluidic modules supported by the frame, each fluidic module comprising a metal reaction layer having opposed major outer surfaces, a fluid passage disposed within the metal reaction layer, and a plurality of module ports extending between the major outer surfaces of the metal reaction layer, the module ports comprising intersecting ports that intersect the fluid passage;
at least two metal plates between which the fluidic modules are arranged one by one in a first direction that is substantially normal to the major outer surfaces, the at least two metal plates supported by the frame with each metal plate having a plurality of plate ports;
a plurality of metal inserts, each metal insert configured to abut a corresponding pair of ports adjacently spaced in the first direction and comprising at least one intersecting port such that every intersecting port is abutted by at least one metal insert; and
at least two tightening members extending in the first direction through the at least two metal plates and the fluidic modules, the at least two tightening members configured to compress the at least two metal plates and the fluidic modules against the metal inserts.

2. The flow reactor of claim 1, wherein the at least two metal plates comprise a first metal plate fixed to the frame and a second metal plate supported by the frame, the fluidic modules arranged between the first and second metal plates.

3. The flow reactor of claim 1, wherein, when viewed in the first direction, the module ports of each fluidic module are positioned between the at least two tightening members.

4. (canceled)

5. The flow reactor of claim 1, wherein the module ports of each fluidic module are aligned along a common line oriented substantially normal to the first direction.

6. The flow reactor of claim 5, wherein the at least two tightening members are aligned along the common line.

7. The flow reactor of claim 5, wherein the metal reaction layer of each fluidic module has a plurality of edges extending between the major outer surfaces thereof, the module ports of each fluidic module positioned closer to one of the edges.

8. (canceled)

9. The flow reactor of claim 1, wherein each tightening member is elongate in the first direction.

10. The flow reactor of claim 1, wherein each tightening member has at least two contact portions configured to abut respective outer surfaces of the at least two metal plates, and wherein at least one contact portion of each tightening member is configured to adjust a distance along the tightening member between the at least two contact portions.

11. (canceled)

12. The flow reactor of claim 10, wherein each tightening member is configured as a threaded rod and at least one contact portion of each tightening member is configured as a threaded nut that engages the threaded rod, and wherein each contact portion of each tightening member is configured as a threaded nut that engages the threaded rod.

13. (canceled)

14. The flow reactor of claim 1, wherein each metal insert comprises a first body portion that is monolithic and extends between opposed end faces thereof along a central axis oriented substantially parallel to the first direction.

15. The flow reactor of claim 14, wherein one or more of:
the first body portion is elongate in the first direction,
the first body portion has a cylindrical shape when viewed in a cross section oriented substantially normal to the first direction,
each end face of each metal insert has a surface portion oriented substantially normal to the first direction, and
each end face of each metal insert has a protrusion that extends therefrom, the protrusions configured to be received in the corresponding pair of ports abutted by the metal insert.

16. (canceled)

17. (canceled)

18. (canceled)

19. (canceled)

20. (canceled)

21. The flow reactor of claim 1, wherein the metal inserts comprise first inserts configured to interchangeably abut the corresponding pairs of ports, each first insert configured to a set a first flow condition in which the ports of the corresponding pair of ports are fluidically connected to one another.

22. The flow reactor of claim 1, wherein the metal inserts comprise second inserts configured to interchangeably abut the corresponding pairs of ports, each second insert configured to set a second flow condition in which the ports of the corresponding pair of ports are fluidically isolated from one another.

23. The flow reactor of claim 1, wherein the metal inserts comprise third inserts configured to interchangeably abut the corresponding pairs of ports, each third insert configured to set a third flow condition in which the ports of the corresponding pair of ports are fluidically connected to one another and to a first port.

24. The flow reactor of claim 1, wherein the metal inserts comprise fourth inserts configured to interchangeably abut the corresponding pairs of ports, each fourth insert configured to set a fourth flow condition in which (i) the ports of the corresponding pair of ports are fluidically isolated from one another and (ii) one port of the corresponding pair of ports is fluidically connected to a second port.

25. The flow reactor of claim 1, wherein the metal reaction layer of each fluidic module, the at least two metal plates, the metal inserts, and portions of the at least two tightening members are formed from a same metal.

26. (canceled)

27. The flow reactor of claim 25, wherein one or more of the fluidic modules comprises a heat exchanger, each heat exchanger comprising two heat exchange layers attached, respectively, to the major outer surfaces of the metal reaction layer of each of the one or more fluidic modules to define heat exchange fluid passages therebetween.

28. The flow reactor of claim 27, wherein one or more of:
each heat exchange layer has a recessed portion that delimits an exposed portion of the major outer surface that is not covered by the heat exchange layer, the module ports of each of the one or more fluidic modules disposed within the exposed portion, and
at least one adjacent pair of the fluidic modules comprises the heat exchangers, the metal inserts disposed between the at least one adjacent pair of the fluidic modules configured to provide a minimum gap between the heat exchangers in the first direction.

29. (canceled)

30. (canceled)

31. The flow reactor of claim 27, wherein one or more of:
the two heat exchange layers of each heat exchanger are sealed, respectively, to the major outer surfaces of the metal reaction layer of each of the one or more fluidic modules, and
the two heat exchange layers of each heat exchanger are fastened, respectively, to the major outer surfaces of the metal reaction layer of each of the one or more fluidic modules.

32. (canceled)

33. (canceled)

34. (canceled)

35. The flow reactor of claim 1, wherein the module ports comprise non-intersecting ports that do not intersect the fluid passage, and wherein the corresponding pair of ports abutted by each metal insert comprises (i) two intersecting ports, (ii) one intersecting port and one non-intersecting port, or (iii) one intersecting port and one plate port.
